(19) United States
(12) Patent Application Publication
(10) Pub. No.: US 2019/0206248 A1
(43) Pub. Date: Jul. 4, 2019

(54) ROADWAY SAFETY SYSTEM

(71) Applicant: Joseph Carroll, Great Meadows, NJ (US)

(72) Inventor: Joseph Carroll, Great Meadows, NJ (US)

(21) Appl. No.: 16/157,239

(22) Filed: Oct. 11, 2018

Related U.S. Application Data
(60) Provisional application No. 62/611,630, filed on Dec. 29, 2017.

(51) Int. Cl. G08G 1/095; E01F 9/615; F21S 9/03; F21V 23/04; F21S 10/06; F21S 4/20; G08G 1/07; G08B 5/38

(52) U.S. Cl. CPC G08G 1/095; E01F 9/615; F21S 9/032; F21V 23/0471; F21Y 2115/10; F21S 4/20; G08G 1/07; G08B 5/38; F21S 10/06

(57) ABSTRACT

A roadway safety system that alerts drivers that animals, especially deer, or humans, have entered a roadway so that the driver can avoid accidents resulting therefrom, such as hitting or killing the animal, or human, or damaging his or her vehicle or other vehicles, or harming himself or herself or his or her passengers in an attempt to avoid a collision.

### CROSS REFERENCE TO RELATED APPLICATION

This application claims the benefit of U.S. Provisional Application No. 62/611,630 filed on Dec. 29, 2017.

### FIELD OF THE INVENTION

The instant invention relates to accident prevention and highway safety systems.

### BACKGROUND OF THE INVENTION

The incidence of automobile, truck, and bus accidents caused by deer entering highways and streets continues to increase unabated. The problem to be solved by the instant invention is to prevent the loss of the innocent life of drivers and passengers because of accidents involving deer and other animals, or people, entering roadways in front of cars, buses, and trucks.

### SUMMARY OF THE INVENTION

The problem to be solved is preventing innocent life from being taken because of accidents that need not happen because of the lack of technology that would make drivers aware that an animal, especially a deer, has wandered onto the roadway in the path their vehicle. This invention solves the problem by providing alerts that make drivers aware of an animal, or possibly a person, entering the roadway in the path of the vehicle, so that the driver can avoid hitting or killing the animal, or person, and damaging his or her vehicle or other vehicles, or harming himself or herself or his or her passengers. The disclosed system will help today's drivers that are distracted by texting, talking on the phone, or not paying attention while driving as well. The disclosed system provides alerts in the form of flashing lights to make a driver aware of deer or other animals in the roadway. Even the distracted driver will be alerted to danger. For up to forty five seconds the blinking light will alert the driver, and once the animal is out of sensor zone the lights will then go off. The instant system will avoid animals, or even humans, from being injured or killed and in the long run this system has the ability to also save consumers on insurance premiums by reducing accidents and deaths. The instant system takes advantage of certain colored lights to warn drivers in high danger areas, such as around sharp corners, or in places in which animals, or people, are more likely to be crossing the road.

### BRIEF DESCRIPTION OF THE DRAWINGS

FIG. 1 is a perspective view of the components of the system of the present invention.

### DETAILED DESCRIPTION OF THE INVENTION

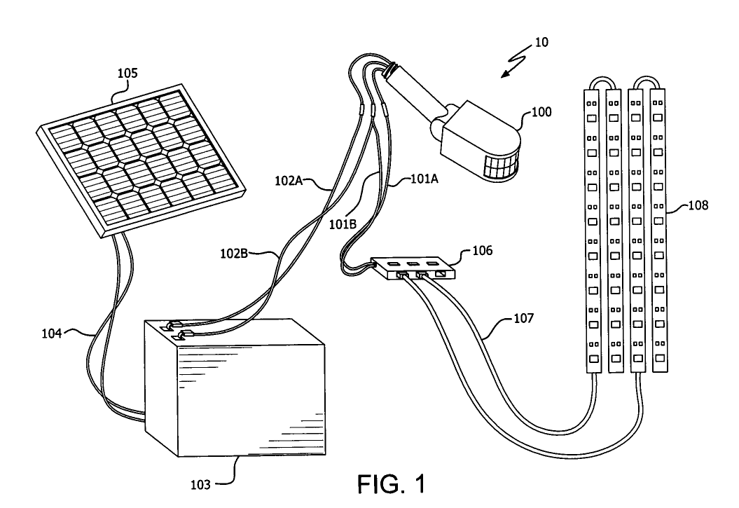

FIG. 1 depicts the component parts of the roadway safety system 10 of the instant disclosure. The system, referred to as the A.L.E.R.T. System (Animal Life Emergency Reaction Time System) is comprised of a solar panel 105 connected via cables 104 to a rechargeable battery 103. Battery 103 powers system 10 through its hot output cable 102A and negative output cable 102B. Infrared motion sensor 100 is powered by battery 103 by said cables 102A and 102B. Said motion sensor 100 powers and controls strobe box 106 through its output cable 101A as an input signal to strobe box 106. Said strobe box 106 is connected to the negative terminal of battery 103 by cables 101B and 102B. Said strobe box 106 pulsates on receiving signals through cable 101A providing an output through cables 107 as an input to LED light strips 108 that controls a panoply of RGB multicolor lights in LED light strips 108.

Putting the instant system 10 of the preferred embodiment into best use at the side of a roadway at which there are known crossings by deer, or people, requires that LED light strips 108 be strategically placed at the point at which motorists are most likely to be alerted to crossings. Light strips 108 flash a predetermined time as preset by a user in programmable motion sensor 100. Solar panel 105 is to be positioned to maximize the incidence of sun rays, since solar panel 105 is necessary to keep battery 103 charged over long periods of use. The installer of system 10 must properly connect cables 104 from panel 105 to rechargeable battery 103 and connect output cables 102A and 102B from battery 103 to IR motion sensor 100. Said motion sensor 100 must be properly positioned by the installer of system 10 at an optimal spot near the roadway that is to be protected in order to detect deer or people entering the roadway. The installer of system 10 must hook up output 101A of motion detector 100 to the input of strobe box 106 in order to properly drive the pulsating box 106, and must complete the circuit for said strobe box 106 by connecting cable 101B to cable 102B that connects the negative terminal of battery 103. Output cables 107 from strobe box 106 must be properly connected to LED strips 108. The installer can program the motion detector 100 in order to preset the blinking time of alert. The color of the blinking alerting lights can be changed by changing the colors of the RGB lights in LED light strips 108.

As can be appreciated by one skilled in the art, the preferred embodiment of system 10 as described herein is but one implementation of the disclosed invention and this description is not intended to limit the scope of the disclosure herein.

What is claimed is:

1. A roadway safety system comprising:
a power source;
a motion detector powered by said power source; and
warning lights powered by said power source and controlled by said motion detector,
whereby such warning lights are positioned to alert to drivers of vehicles on a roadway of the incursion by animals or humans onto such roadway in the path of said vehicle in order that said driver can take action to avoid accidents in connection with said incursion.

2. A roadway safety system of claim 1 in which said power source is rechargeable.

3. A roadway safety system of claim 2 further comprising:
a solar panel connected to said rechargeable power source,
whereby a continuous source of electric power is provided to said power source.

4. A roadway safety system of claim 1 further comprising:
a strobe box connected to the output of said motion detector and connected to the input of said warning lights,
whereby said output of said strobe box pulsates to cause said warning lights to blink in order to enhance the alerting of said drivers.

5. A roadway safety system of claim 1 in which said motion sensor is an infrared motion sensor.

6. A roadway safety system of claim 1 in which said warning lights are RGB multicolor light LED light strips.

7. A roadway safety system of claim 4 in which said motion detector is programmable by the user of said system whereby said blinking of said lights can be controlled in time by programming of said motion detector by said user.
